(19) United States
(12) Patent Application Publication
(10) Pub. No.: US 2008/0271833 A1
(43) Pub. Date: Nov. 6, 2008

(54) Personalizing device and method

(76) Inventor: Matthew A. Tennant, Anchorage, AK (US)

Correspondence Address: JAMES RAY & ASSOCIATES, 2640 PITCAIRN ROAD, MONROEVILLE, PA, 15146, US

(21) Appl. No.: 12/082,600

(22) Filed: Apr. 11, 2008

Related U.S. Application Data
(60) Provisional application No. 60/913,672, filed on Apr. 24, 2007.

(51) Int. Cl. B32B 37/00

(52) U.S. Cl. 156/85; 156/349

(57) ABSTRACT

A device for personalizing a predetermined object is provided. Such device includes a covering member having pre-selected indicia thereon for at least one of encircling and covering a predetermined portion of such predetermined object. Such covering member is manufactured from a predetermined material, and has a predetermined size and a predetermined shape. Such device also includes a securing mechanism for securing such covering member at least one of to and around such predetermined portion of such predetermined object.

### CROSS REFERENCE TO RELATED APPLICATION

This patent application is related to and claims priority from U.S. Provisional Patent Application Ser. No. 60/913,672 filed Apr. 24, 2007.

### FIELD OF THE INVENTION

The present invention relates, in general, to personalizing and labeling devices and, more particularly, this invention relates to devices for personalizing objects such as tools and the like with heat shrinkable film.

### BACKGROUND OF THE INVENTION

Prior to the conception and development of the present invention, adhesive labels, as are generally well known in the prior art, have been used by people to identify their personal items. However, such labels often peel or wear off resulting in ugly marks and annoying sticky spots left behind on the item which bore the label. Additionally it is difficult to remove such labels or change such labels in the event that a new label is desired.

Therefore there exists a need for an improved means of personalization which can be applied easily to a variety of objects without mess or fuss. More particularly, a need exists for a device for labeling and personalizing hand held items such as tools.

People often use a variety of hand held items such as tools while on the job, when participating in hobbies, for home repair, auto repair and the like. As many such items are very similar in size and appearance, there is a particular need for a device for personalizing hand held objects such as tools, thereby making identification of the owner of such item quick and easy.

Specifically of interest to the present invention are the following: Hoffman, U.S. Pat. No. 4,416,714 discloses a machine and method for applying heat shrink labels to articles having cylindrical body portions and an end portion or portions adjoining the body portion and sloping inwardly therefrom. The label's leading end overlaps the trailing end and a seam is formed at the overlap. The label is secured to the article by adhesive between the leading end and the container and by adhesive between the overlapping leading end and trailing end. The label is of a width such that it projects beyond the junction or junctions of the end portion or portions with the body portion, resulting in free standing edge or edges which are then heat shrunk onto the container by heat from an external source.

Hoffmann, U.S. Pat. No. 4,545,832, discloses a method and apparatus for heat shrinking projecting edges of heat shrinkable (but unshrunken) film onto articles such as cylindrical containers. The film is tightly wrapped around the bodies of the articles and the overlapping ends are held together by glue. The projecting edges of the articles are then heat shrunk onto the shoulders and/or curved lower ends of the bodies.

Rajan, et al, discloses a halogen-free, multilayered, uni-axially oriented heat shrink film comprising (A) a core layer comprising a blend of polyolefins, (B) a first skin layer on the upper surface of the core layer, and (C) a second skin layer on the lower surface of the core layer, wherein the first and second skin layers independently comprise a polyolefin blend and wherein the shrinkage of the film is at least about 40% in the machine direction at 270° F. Such shrink film includes a label having an adhesive applied to at least a portion of at least one of the skin layers. The heat shrink labels are used to encapsulate articles.

Hoffman, U.S. Pat. No. 4,406,721 discloses a machine and method for applying heat shrink labels to articles such as containers having cylindrical body portions and an end portion or portions adjoining the body portion and sloping inwardly therefrom. The label has a leading end overlapping its trailing end and a seam is formed at the overlap. The label is secured to the article by adhesive between the leading end and the container and by adhesive between the overlapping leading end and trailing end. The label is of a width such that it projects beyond the junction or junctions of the end portion or portions with the body portion, resulting in free standing edge or edges which are then heat shrunk onto the container.

Kanai, U.S. Pat. No. 6,875,485, discloses a resin composition for heat-shrinkable polypropylene shrink label, comprises: from 50 to 95% by weight of a crystalline propylene-α-olefin random copolymer mainly comprising propylene and from 5 to 50% by weight of an alicyclic hydrocarbon resin having a softening temperature of not lower than 110 degrees Celsius.

Fresnel, et al, U.S. Pat. No. 6,317,046 discloses a device for making an antitheft link between two objects, the device comprising an envelope of heat-shrink plastics material which is designed to envelop one of the two objects to be connected together, and an auxiliary compartment in which an elongate pin is disposed. The elongate pin provides a link between the other object and the envelope which has been heat-shrunk on the first object. An anti-theft means in the form of a metal filament is meant to be attached to the device.

The above cited references are geared toward shrink wrapping articles containing consumable products and products in commerce as a means for protecting the items from tampering and theft. None of the prior art references the need for a device which can be used to personalize objects such as tools and the like.

### SUMMARY OF THE INVENTION

The present invention provides a device for personalizing a predetermined object. Such device includes a covering member having pre-selected indicia thereon for at least one of encircling and covering a predetermined portion of such predetermined object. The covering member is manufactured from a predetermined material, and has a predetermined size and a predetermined shape. The device further includes a securing means for securing such covering member at least one of to and around such predetermined portion of such predetermined object.

According to another embodiment, a method of personalizing a predetermined object is provided. Such method includes the steps of selecting such predetermined object, providing a covering member having pre-selected indicia thereon, at least one of encircling and covering a predetermined portion of such predetermined object with such covering member, and securing such covering member at least one of to and around such predetermined portion of such predetermined object.

According to another embodiment, a method of personalizing a predetermined object is provided. Such method includes the steps of selecting such predetermined object, providing a heat shrinkable covering member having pre-selected indicia thereon, at least one of encircling and covering a predetermined portion of such predetermined object with the heat shrinkable covering member, and applying heat to the heat shrinkable covering member such that the heat shrinkable covering member shrinks and is secured at least one of to and around such predetermined portion of such predetermined object.

### OBJECTS OF THE INVENTION

It is, therefore, one of the primary objects of the present invention to provide a device which enables a user to personalize objects including, but not limited to, tools.

Another object of the present invention is to provide a device which enables a user to personalize an object by using heat to shrink a plastic material having predetermined indicia thereon around a predetermined portion of such object.

Still another object of the present invention is to provide a quick and easy way to customize, decorate, and personalize tool handles and the like with heat shrinkable film.

Yet another object of the present invention is to provide a means for securing particular information relating to a particular item such as a tool to that particular item, examples would include, but not be limited to, directions for use of such item, and type and number of batteries required for such item to function.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of the invention according to one embodiment of the invention in which a tool handle is about to be partially encircled by the covering member.

FIG. 2 is a partial perspective view of the invention according to one embodiment of the invention in which a tool handle is partially encircled by a heat shrinkable covering member and heat is being applied to such covering member to shrink such covering member around the handle of such tool.

FIG. 3 is a partial perspective view of the invention according to one embodiment of the invention in which the covering member has been secured around a portion of the handle of a tool.

FIG. 4 is a partial perspective view of the invention according to one embodiment of the invention in which the covering member includes an opening at a first predetermined end thereof for receiving at least a portion of a handle of a tool.

FIG. 5 is a partial perspective view of the invention according to one embodiment of the invention in which the covering member includes an opening at a second predetermined end thereof through which a first predetermined end of a tool handle may extend when such covering member encircles such tool handle.

FIG. 6 is a partial perspective view of the invention according to one embodiment of the invention in which a first predetermined side end of the covering member and a second predetermined side end of the covering member may be adhesively joined to form a cylinder.

FIG. 7 is a partial perspective view of the invention according to one embodiment of the invention in which such securing means is a hook and loop type securing means.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

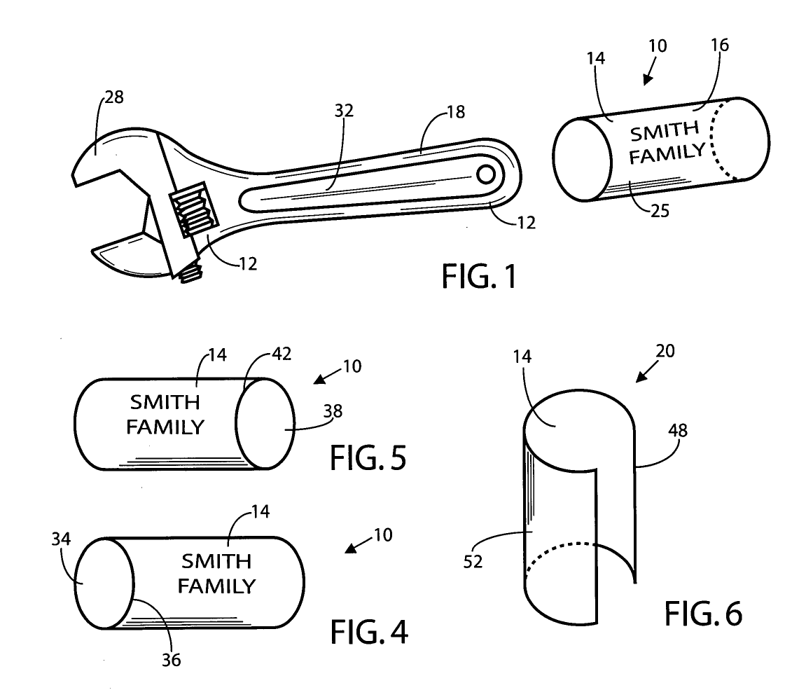

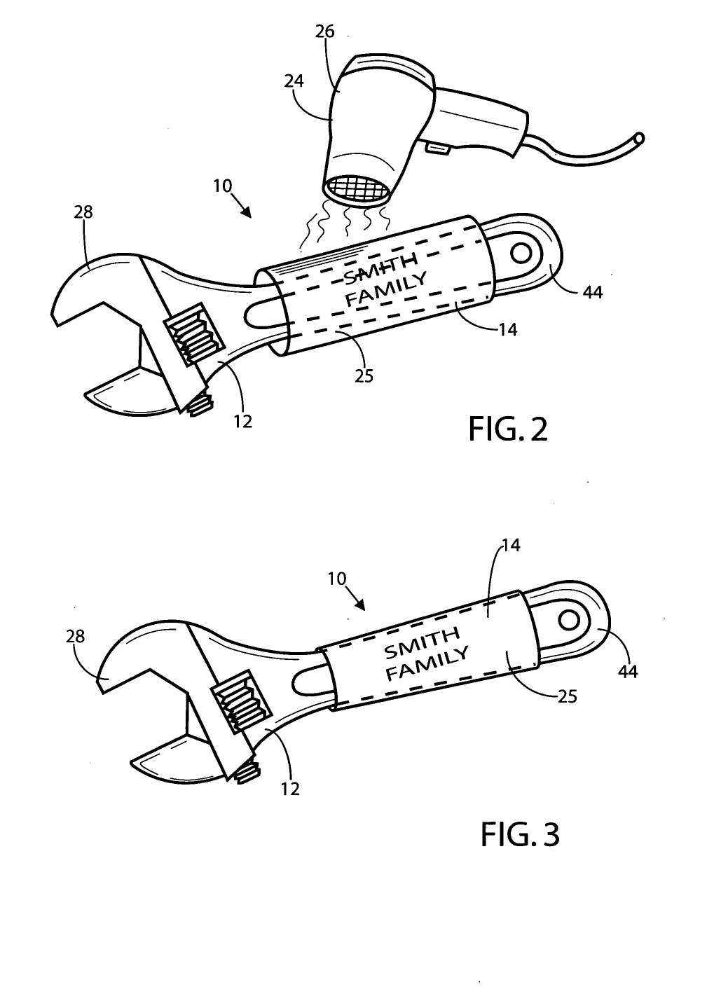

Reference is now made, more particularly, to FIGS. 1-7.

A device, generally designated 10, for personalizing a predetermined object 12 is provided. Such device 10 includes a covering member 14 having pre-selected indicia 16 thereon for at least one of encircling and covering a predetermined portion 18 of such predetermined object 12. The covering member 14 is manufactured from a predetermined material, and has a predetermined size and a predetermined shape.

Such device 10 includes a securing means 24 for securing the covering member 14 at least one of to and around such predetermined portion 18 of such predetermined object 12.

It is presently preferred that the covering member 14 shrinks when heated.

It is presently preferred that such securing means 24 includes a heating means 26 for heating the covering member 14 such that the covering member 14 shrinks to conform to a shape of such predetermined portion 18 of such predetermined object 12.

It is presently preferred that such predetermined material is a plastic. It is presently preferred that such plastic is a heat shrinkable plastic film 25. It is further presently preferred that such plastic is substantially transparent.

It is presently preferred that such predetermined object 12 is a tool 28 having a handle 32. It is further presently preferred that such predetermined portion 18 of such tool 28 having a handle 32 is at least a portion of such handle 32.

It is further presently preferred that the covering member 14 includes a first opening 34 at a first predetermined end 36 thereof for receiving such handle 32 such that the covering member 14 encircles such at least a portion of such handle 32.

It is presently preferred that the covering member 14 includes a second opening 38 at a second predetermined end 42 thereof such that a first predetermined end 44 of such handle 32 extends out of the second opening 38 a predetermined distance when the covering member 14 is at least one of encircling and secured to such handle 32.

It is presently preferred that such predetermined shape of the covering member is substantially cylindrical.

It is presently preferred that such pre-selected indicia 16 includes at least one of information relating to a user, information relating to such predetermined object, warnings, directions, symbols, numbers, letters, pictoral designs, sports teams, school affiliations, business affiliations, political affiliation, religious affiliations, hobbies, photographic images, and a combination thereof.

It is further presently preferred that such information relating to such user includes at least one of name, phone number, address, email, and a combination thereof.

Referring to FIG. 6, according to another embodiment of the invention, generally designated 20, the covering member 14 has a first predetermined side end 48 and a second predetermined side end 52 and such first predetermined side end 48 is adhesively securable to such second predetermined side end 52 such that when such first predetermined side end 48 is secured to such second predetermined side end 52 a cylinder is formed for receiving such predetermined portion 18 of such predetermined object 12.

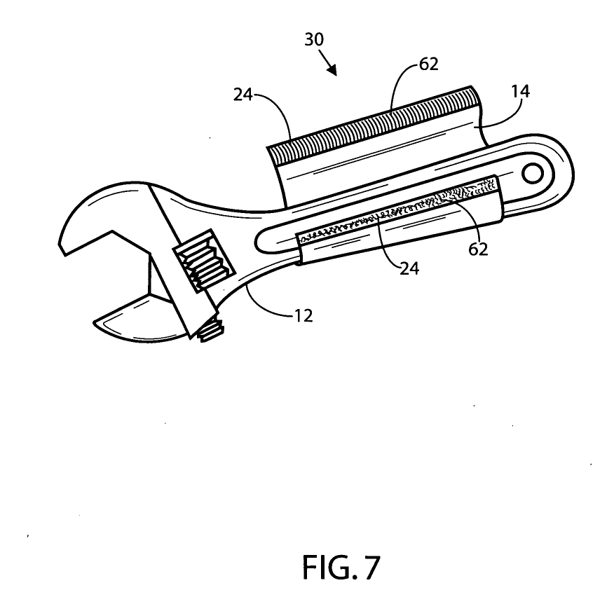

Referring to FIG. 7, according to another embodiment of the invention, generally designated 30, such securing means 24 is at least one of an adhesive type securing means, a hook and loop type securing means 62, snaps, clamps, ties, string, clips, and elastic.

Referring again to FIG. 7, according to one embodiment of the invention, such predetermined material is an elastomer.

According to yet another embodiment of the invention, a method of personalizing a predetermined object is provided. Such method includes the steps of selecting such predetermined object, providing a covering member having pre-selected indicia thereon for at least one of encircling and covering a predetermined portion of such predetermined object, at least one of encircling and covering such predetermined portion of such predetermined object with such covering member, and securing such covering member at least one of to and around such predetermined portion of such predetermined object.

According to still another embodiment of the invention, a method of personalizing a predetermined object is provided. Such method includes selecting such predetermined object, providing a heat shrinkable covering member having pre-selected indicia thereon for at least one of encircling and covering a predetermined portion of such predetermined object, at least one of encircling and covering such predetermined portion of such predetermined object with the heat shrinkable covering member, and applying heat to the heat shrinkable covering member such that the heat shrinkable covering member shrinks and is secured at least one of to and around such predetermined portion of such predetermined object.

Additionally, it is worth noting that while one purpose of the invention may be to personalize an object, it is not meant to be limited as such. Specifically the device and method may also serve to cover and protect such object thereby extending such object's useful life, and may serve to provide identifying information on such object.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A device for personalizing a predetermined object, said device comprising;
a. a covering member having pre-selected indicia thereon for at least one of encircling and covering a predetermined portion of such predetermined object, said covering member being manufactured from a predetermined material, and having a predetermined size and a predetermined shape; and
b. a securing means for securing said covering member at least one of to and around such predetermined portion of such predetermined object.

2. A device according to claim 1 wherein said covering member shrinks when heated.

3. A device according to claim 2 wherein said securing means includes a heating means for heating said covering member such that said covering member shrinks to conform to a shape of such predetermined portion of such predetermined object.

4. A device according to claim 1 wherein said predetermined material is a plastic.

5. A device according to claim 3 wherein said plastic is a heat shrinkable plastic film.

6. A device according to claim 3 wherein said plastic is substantially transparent.

7. A device according to claim 1 wherein such predetermined object is a tool having a handle.

8. A device according to claim 6 wherein such predetermined portion of such tool having a handle is at least a portion of such handle.

9. A device according to claim 7 wherein said predetermined shape of said covering member is substantially cylindrical.

10. A device according to claim 8 wherein said covering member includes a first opening at a first end thereof for receiving such handle such that said covering member encircles such at least a portion of such handle.

11. A device according to claim 9 wherein said covering member includes a second opening at a second end thereof such that a first end of said handle extends out of said second opening a predetermined distance when said covering member is at least one of encircling and secured to such handle.

12. A device according to claim 1 wherein said pre-selected indicia includes at least one of information relating to a user, information relating to such predetermined object, warnings, directions, symbols, letters, numbers, pictoral designs, sports teams, school affiliations, business affiliations, political affiliation, religious affiliations, hobbies, photographic images, and a combination thereof.

13. A device according to claim 11 wherein said information relating to such user includes at least one of a name, phone number, address, email, and a combination thereof.

14. A device according to claim 1 wherein said covering member has a first predetermined side end and a second predetermined side end and said first predetermined side end is adhesively securable to said second predetermined side end such that when said first predetermined side end is secured to said second predetermined side end a cylinder is formed for receiving such predetermined portion of such predetermined object.

15. A device according to claim 1 wherein said securing means is at least one of an adhesive type securing means, a hook and loop type securing means, snaps, clamps, ties, string, clips, and elastic.

16. A device according to claim 1 wherein said predetermined material is an elastomer.

17. A method of personalizing a predetermined object comprising the steps of:
a. selecting said predetermined object;
b. providing a covering member having pre-selected indicia thereon for at least one of encircling and covering a predetermined portion of said predetermined object;
c. at least one of encircling and covering a predetermined portion of said predetermined object with said covering member; and
d. securing said covering member at least one of to and around said predetermined portion of said predetermined object.

18. A method of personalizing a predetermined object comprising the steps of:
a. selecting said predetermined object;
b. providing a heat shrinkable covering member having pre-selected indicia thereon for at least one of encircling and covering a predetermined portion of said predetermined object;
c. at least one of encircling and covering said predetermined portion of said predetermined object with said heat shrinkable covering member; and
e. applying heat to said heat shrinkable covering member such that said heat shrinkable covering member shrinks and is secured at least one of to and around said predetermined portion of said predetermined object.
